(19) United States
(12) Patent Application Publication
(10) Pub. No.: US 2002/0067665 A1
(43) Pub. Date: Jun. 6, 2002

(54) Method for assembling a screwed crown on a watch case

(76) Inventor: Roger Ecoffet, Villers-le-Lac (FR)

Correspondence Address: BAKER & BOTTS, 30 ROCKEFELLER PLAZA, NEW YORK, NY, 10112

(21) Appl. No.: 09/915,905

(22) Filed: Jul. 26, 2001

(30) Foreign Application Priority Data
Dec. 1, 2000 (CH) 2204/99

(51) Int. Cl. G04B 29/00

(52) U.S. Cl. 368/319

(57) ABSTRACT

The invention concerns a method for assembling a screwed crown on a watch case, characterized in that it includes the following steps:

providing a crown with an inner threading the position of which is set with respect to the logo arranged on the front face of the crown;

providing an intermediate tube including two threaded sections;

mounting said intermediate tube in a smooth through hole passing through the case and wedging it on an assembling jig to arrange the thread start of the tube intended to accommodate the internal screw thread of the crown in an angular position such that when the crown is screwed as far as possible onto the tube said logo is located in a determined position; and

providing a nut and immobilizing the tube in said angular position.

### PRIORITY APPLICATION

This is the national phase application of International Application PCT/EP 00/12304 filed on Dec. 1, 2000, which itself claims priority to Swiss Patent Application No. 2204/99 filed on Dec. 2, 1999.

### BACKGROUND OF INVENTION

The present invention concerns a method for assembling a screwed crown, such as a winding crown, onto a watch case.

More particularly, the invention concerns an assembly method of this type allowing the position of a screwed crown on a watch case to be set with respect to a pointer on the face of a watch case so that a logo placed on the front of said crown can always be easily brought into a determined position or orientation after having been unscrewed.

The manufacture and assembly of screwed crowns onto watch cases are well known. However, the assembly methods for these crowns have an important drawback. Known assembly methods do not allow one to ensure that the crown has been brought into a determined orientation with respect to the case after having been unscrewed, which is detrimental to the aesthetic appearance of the case when a mark or logo is affixed to a face of the crown. This situation is of course unacceptable when such crowns are fitted to luxury and high quality products.

### SUMMARY OF INVENTION

The main object of the present invention is to overcome the drawbacks of the aforementioned prior art by providing a simple and economical method for assembling a crown including a logo or a mark which systematically allows the crown to be screwed back into a determined position or orientation after having been unscrewed.

The invention therefore concerns a method for assembling a screwed crown on a watch case, characterized in that it includes the following steps:

providing a crown with an inner threading, the position of which is set with respect to the logo arranged on the front face of the crown;

providing an intermediate tube including two threaded sections;

mounting said intermediate tube in a smooth through hole of the case and wedging it on an assembling jig to arrange the thread start of the tube intended to accommodate the internal screw thread of the crown in an angular position such that when the crown is screwed as far as possible onto the tube said logo is located in a determined position; and

providing a nut and immobilizing the tube in said angular position.

According to an advantageous feature of the invention, the manufacture of the crown with the angularly set internal screw thread includes the following steps:

providing a threaded ring;

positioning said ring using an assembling jig so as to set the position of said internal screw thread with respect to a logo or a mark borne by the face of said crown; and

immobilizing said ring on said crown in said set position.

### BRIEF DESCRIPTION OF THE DRAWINGS

Further objects, features and advantages of the invention will become apparent from the following detailed description taken in conjunction with the accompanying figures showing a preferred embodiment of the invention, of which:

FIG. 1 shows a cross-section of the crown assembled in accordance with the method of the invention; and

FIG. 2 shows an exploded view of the crown prior to implementation of the method of the invention.

### DETAILED DESCRIPTION OF THE PREFERRED EMBODIMENT

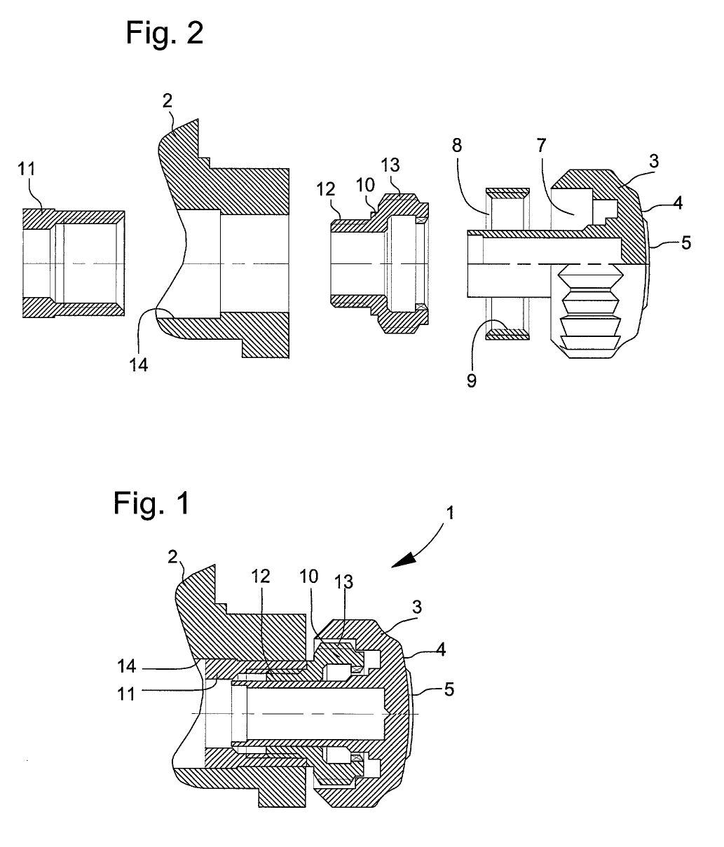

The method for assembling a screwed crown 1 onto a watch case 2 which is only partially shown in the drawing, will be described hereinafter in conjunction with FIGS. 1 and 2. Screwed crown 1 includes a first portion formed of a head 3 having a front face 4 onto which is affixed a logo or a mark 5 which, in its screwed-in position has a determined angular orientation with respect to case 2. This first portion is connected to the movement in a conventional manner.

On the opposite side to frontal face 4, head 3 is provided with an annular groove 7 which accommodates a ring 8 with an internal screw thread 9. Ring 8 is positioned in groove 7 by using an assembling jig (not shown) so as to set the position of said internal screw thread 9 with respect to logo 5 and it is immobilized in groove 7 in said angularly set position. The position setting operation is preferably carried out using a camera and the immobilizing operation by a welding operation for example laser welding. Logo 5 consequently has a determined and known angular position with respect to the start of internal screw thread 9.

The crown further includes a second portion connected to case 2. This second portion includes an intermediate tube 10 and a nut 11 intended to immobilize tube 10 in a determined angular position on case 2. Tube 10 includes two externally threaded sections 12 and 13 which co-operate respectively with nut 11 and angularly set internal screw thread 9. According to the method of the invention, tube 10 is freely mounted in a smooth through hole 14. Tube 10 is then wedged using an assembling jig (not shown) to arrange the start of threading 13 in an angular position such that when crown 1 is screwed as far as possible onto tube 10 said logo 5 is located in a determined angular position with respect to the case. Once this wedging operation has been completed, tube 10 is immobilized by nut 11.

Although preferred embodiments of the invention have been disclosed for illustrative purposes, those skilled in the art will appreciate that many additions, modifications, and substitutions are possible without departing from the true scope and spirit of the invention as defined by the accompanying claims.

I claim:

1. A method for assembling a screwed crown on a watch case, wherein said crown includes a head having a front face with a logo, comprising the following steps:
providing said crown with an inner threading, the position of which is set with respect to said logo;
providing an intermediate tube including two threaded sections, one having a thread start adapted to accommodate said inner threading;
providing said case with a smooth-through hole, and mounting said intermediate tube in said smooth-through hole;
wedging said intermediate tube to arrange the thread start in an angular position such that when the crown is screwed onto the tube said logo is located in a determined position;
using a nut to immobilize the tube in said angular position.

2. A method for manufacturing a crown with an indexed internal screw thread, comprising the following steps:
providing a threaded ring;
using an assembling jig to position said ring and angularly set the position of said internal screw thread with respect to a logo or a mark borne by the face of said crown; and
immobilizing said ring on said crown in said angularly set position.
